(19) United States
(12) Patent Application Publication
(10) Pub. No.: US 2024/0416730 A1
(43) Pub. Date: Dec. 19, 2024

(54) MANUALLY DEPLOYABLE VEHICLE DOOR CURTAIN ASSEMBLY

(71) Applicants: Hyundai Motor Company, Seoul (KR); Kia Corporation, Seoul (KR); Ashimori Korea Co., Ltd., Wonju-si (KR)

(72) Inventors: Chan-Seung Kim, Suwon-si (KR); Eun-Pyo Hong, Hwaseong-si (KR); Sung-Ju Lee, Wonju-si (KR)

(21) Appl. No.: 18/491,960

(22) Filed: Oct. 23, 2023

(30) Foreign Application Priority Data
Jun. 19, 2023 (KR) 10-2023-0078298

(51) Int. Cl. B60J 1/20

(52) U.S. Cl. CPC B60J 1/2086; B60J 1/2033; B60J 1/2052

(57) ABSTRACT

An embodiment manually deployable vehicle door curtain assembly includes a curtain retractable into a vehicle door and deployable to cover a door window glass, a rod configured to be mounted on the vehicle door and to be simultaneously movable with the curtain to support the curtain, a slider slidably coupled with the rod and movable up and down together with the rod, and a support member configured to allow or prevent descending movement of the slider.

### CROSS-REFERENCE TO RELATED APPLICATIONS

This application claims the benefit of Korean Patent Application No. 10-2023-0078298, filed on Jun. 19, 2023, which application is hereby incorporated herein by reference.

### TECHNICAL FIELD

The present disclosure relates to a vehicle door curtain assembly.

### BACKGROUND

The doors of a vehicle are equipped with door glasses for light-admission and ventilation.

Furthermore, a door curtain (hereinafter referred to as a “curtain”) covering the door glass is optionally installed on a door for light-shading and privacy-protection.

The curtain is retracted inside the door when not in use and is withdrawn from the door when in use and deployed parallel to the door glass.

The curtain is provided with a shade bar at a top portion of the curtain to evenly unfold the curtain when the curtain is deployed.

Typically, when the curtain is deployed, the shade bar is fastened to a door frame. To this end, a hook is provided on the door frame for securing the shade bar when the curtain is deployed. After the curtain is deployed, the shade bar is configured to be secured on the hook, so that the curtain remains evenly deployed.

On the other hand, in recent years, the application of a frameless door, in which a door frame supporting the perimeter of the door glass at an upper part of the door is removed, has been expanding.

Due to the absence of a door frame, the frameless door has a problem that the shade bar cannot be secured to the door when the curtain is deployed, so the curtain may not be applied to the frameless door.

However, even in a case in which the door frame is applied, the hooks are exposed, which reduces the appearance of the door, and a gap is inevitably created between the shade bar and the door frame for coupling the shade bar and the hooks.

The contents described in this section are to help the understanding of the background of embodiments of the present disclosure and may include what is not previously known to those skilled in the art to which the present disclosure pertains.

### SUMMARY

The present disclosure relates to a vehicle door curtain assembly. Particular embodiments relate to a vehicle door curtain assembly that is capable of being manually deployed and maintained in a deployed state without a top portion of the curtain assembly being secured to the door, and then automatically retracted.

Embodiments of the present disclosure have been devised to solve problems in the art, and an embodiment of the present disclosure provides a manually deployable vehicle door curtain assembly that, when a curtain is deployed by an occupant, allows the curtain to remain evenly deployed without hooking a top portion of the curtain to a door frame using a hook or the like.

Another embodiment of the present disclosure provides a manually deployable vehicle door curtain assembly, wherein a curtain is automatically retracted into an interior of a door when an occupant operates a button or when a door glass is lowered.

In an embodiment of the present disclosure, a manually deployable vehicle door curtain assembly includes a curtain capable of being retracted into a vehicle door and deployed to cover a door window glass, a rod mounted on the vehicle door and simultaneously movable with the curtain to support the curtain, a slider slidably coupled with the rod and movable up and down together with the rod, and a support member configured to allow or prevent descending movement of the slider.

When the curtain is deployed, the support member is positioned at an initial position to support a bottom surface of the slider so that the curtain remains deployed, and when the support member is moved away from the initial position, it allows the slider to be movable so that the curtain is retracted into an interior of the vehicle door.

The support member may be a stopper that is mounted to be elastically supported toward an ascending/descending trajectory of the slider on the rod.

The stopper may have an inclined surface coming into contact with the slider during the ascending of the slider and a stop surface extending from an upper end of the inclined surface in a direction perpendicular to the ascending/descending direction of the slider.

The stopper may be rotatably mounted on the vehicle door and may be elastically supported toward the trajectory of the slider by a torsion spring.

The stopper may have, on the opposite side of the inclined surface, an engaging protrusion extending from the stop surface.

When a button for operating the stopper is provided on one side of the vehicle door and is operated, the stopper may be moved away from the ascending/descending trajectory of the slider.

The button may be connected to the stopper by a first cable, and when the button is operated so that the first cable is pulled, the stopper may be moved away from the ascending/descending trajectory of the slider.

The vehicle door may be provided with an actuating lever operated by the door window glass upon descending of the door window glass, and when the actuating lever is operated, the stopper may be moved away from the ascending/descending trajectory of the slider.

The actuating lever may be rotatably mounted on the vehicle door so that one side of the actuating lever is rotated by a lower end of the door window glass upon descending of the door window glass, and the other side of the actuating lever is connected with the stopper by a second cable such that the stopper is moved away from the ascending/descending trajectory of the slider upon rotation of the actuating lever.

A roller may be mounted on one side of the actuating lever.

A first actuator may be provided to actuate the stopper away from the ascending/descending trajectory of the slider, and the first actuator and the stopper may be connected by an actuating wire such that when the first actuator pulls the actuating wire, the stopper is moved away from the ascending/descending trajectory of the slider.

The support member may be a second actuator telescopically mounted in the trajectory of the slider, and a sensor may be mounted on an upper portion of the second actuator to detect the slider.

When the sensor detects that the slider is positioned higher than the sensor, the second actuator may be stretched to support the bottom surface of the slider so that the curtain remains deployed, and when a switch is operated, the second actuator may be moved away from the ascending/descending trajectory of the slider so that the curtain is retracted into the interior of the door.

The vehicle door may be provided with a guide rail in the ascending/descending direction of the rod, and the slider may be slidably mounted on the guide rail.

The guide rail may further include a damper to cushion the slider upon completion of the descending operation of the slider.

The damper may be mounted at a lower end of the guide rail, and a contactor in contact with the slider may be mounted at an upper end of the damper.

The damper may be mounted on an outer side of the guide rail, and a seating bracket may be further provided so as to be slidably mounted in the guide rail such that the slider is seated therein upon completion of the descending operation of the slider, and the seating bracket may be connected with the damper by a buffer wire.

A shade bar may be mounted on the upper end of the curtain along a longitudinal direction of a vehicle, the shade bar being coupled to the upper end of the rod.

According to the manually deployable vehicle door curtain assembly of embodiments of the present disclosure having the above configuration, since the upper end of the curtain is not fixed to the door frame, the door curtain assembly may be applied to the vehicle door with or without the door frame. Accordingly, the semi-automatic curtain may also be applied to a frameless type door.

Since the curtain is manually deployed by an occupant, but when accommodated, it is automatically retracted by the elastic force of a spring, it is possible to use the curtain conveniently. In addition, the structure is simplified because no electric motor components for deploying or retracting the curtain and no electric components for controlling the electric motor components are applied. Furthermore, the production costs can be lowered because expensive electric motor components and electric components are not applied.

### BRIEF DESCRIPTION OF THE DRAWINGS

FIG. 1 is a schematic view illustrating a manually deployable vehicle door curtain assembly according to an embodiment of the present disclosure;

FIG. 2 is an exploded perspective view illustrating the manually deployable vehicle door curtain assembly of an embodiment of the present disclosure;

FIG. 3 is a schematic view illustrating the manually deployable vehicle door curtain assembly of an embodiment of the present disclosure in which a curtain is partially deployed;

FIG. 4 is a schematic view illustrating the relationship between a slider and a stopper before the curtain is deployed in the manually deployable vehicle door curtain assembly of an embodiment of the present disclosure;

FIG. 5 is a schematic view illustrating the relationship between the slider and the stopper while the slider passes through the stopper in the manually deployable vehicle door curtain assembly of an embodiment of the present disclosure;

FIG. 6 is a schematic view illustrating the relationship between the slider and the stopper after the curtain is deployed in the manually deployable vehicle door curtain assembly of an embodiment of the present disclosure;

FIG. 7 is a schematic view illustrating the relationship between the slider and the stopper before a button is operated in the manually deployable vehicle door curtain assembly of an embodiment of the present disclosure;

FIG. 8 is a schematic view illustrating the relationship between the slider and the stopper when the button is operated to manually retract the curtain in the manually deployable vehicle door curtain assembly of an embodiment of the present disclosure;

FIG. 9 is a schematic view illustrating the configuration in which the slider descends in conjunction with a descending operation of a door window glass in the manually deployable vehicle door curtain assembly of an embodiment of the present disclosure;

FIG. 10 is a schematic view illustrating the relationship between the slider and the stopper when the curtain is retracted in conjunction with the descending operation of the door window glass in the manually deployable vehicle door curtain assembly of an embodiment of the present disclosure;

FIG. 11 is a schematic view illustrating one example of a damper in the manually deployable vehicle door curtain assembly of an embodiment of the present disclosure;

FIG. 12 is a perspective view illustrating the state in which a shade bar strikes a door trim upon completion of the retraction of the curtain in the manually deployable vehicle door curtain assembly of an embodiment of the present disclosure;

FIG. 13 is a cross-sectional view illustrating the state in which an actuator is connected to the stopper in the manually deployable vehicle door curtain assembly of an embodiment of the present disclosure;

FIG. 14 is a cross-sectional view illustrating the state in which the stopper is operated by the actuator in the manually deployable vehicle door curtain assembly of an embodiment of the present disclosure;

FIG. 15 is a schematic view illustrating the manually deployable vehicle door curtain assembly of an embodiment of the present disclosure in which an actuator is applied instead of the stopper and the slider is positioned higher than a sensor;

FIG. 16 is a schematic view illustrating the manually deployable vehicle door curtain assembly of an embodiment of the present disclosure in which the slider is supported by the actuator;

FIG. 17 is a schematic view illustrating the manually deployable vehicle door curtain assembly of an embodiment of the present disclosure in which the actuator is retracted so that the slider descends; and

FIG. 18 is a cross-sectional view illustrating another example of a damper in the manually deployable vehicle door curtain assembly of an embodiment of the present disclosure.

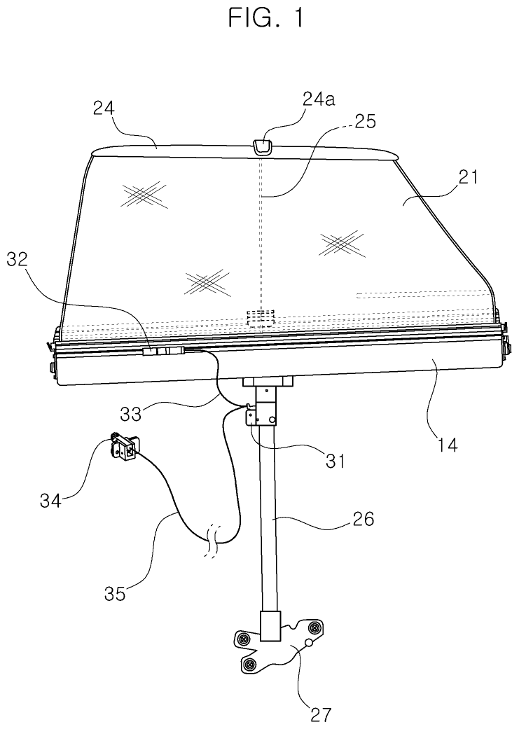

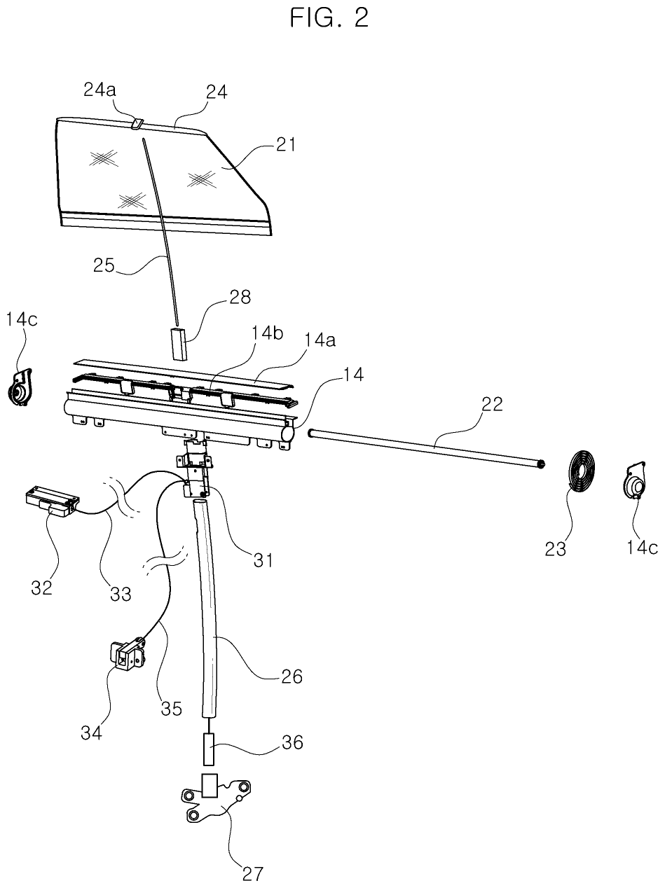

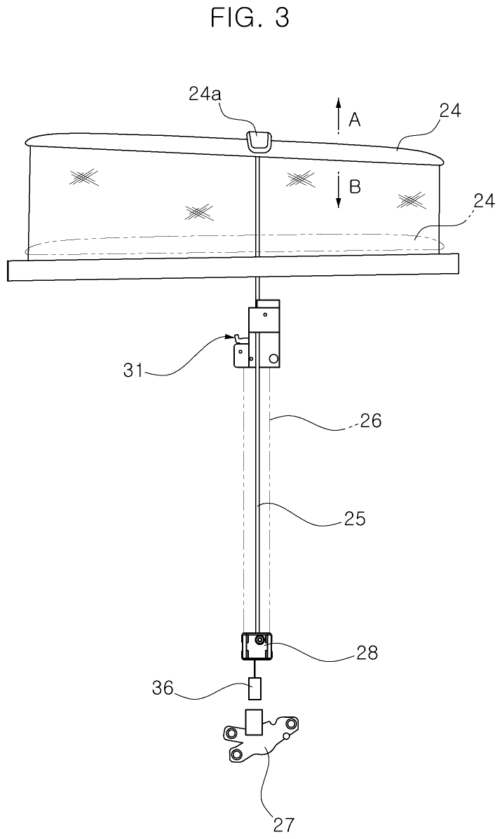

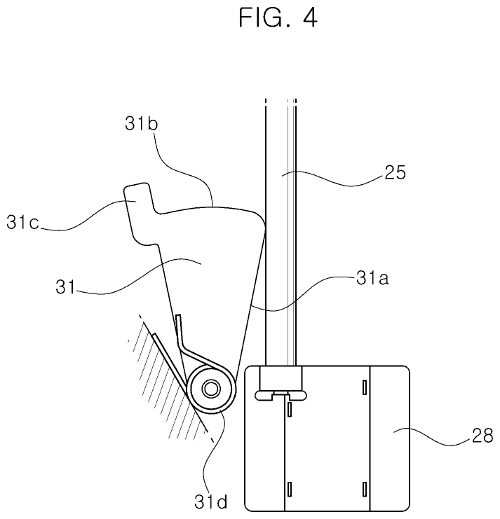

### DETAILED DESCRIPTION OF ILLUSTRATIVE EMBODIMENTS

A manually deployable vehicle door curtain assembly according to embodiments of the present disclosure will now be described in detail with reference to the accompanying drawings.

The manually deployable vehicle door curtain assembly includes a curtain 21 wound and retracted into an interior of a vehicle door and deployed to cover a door window glass 12 when withdrawn from the door, a rod 25 vertically movably mounted on the vehicle door with an upper end thereof fixed to an upper end of the curtain 21 to support the curtain 21 in a deployed state, a slider 28 fixed to a lower end of the rod 25 and movable up and down together with the rod 25, and a support member located in an ascending/descending trajectory of the slider 28 and impeding the descending of the slider 28, wherein when the curtain 21 is deployed, the support member supports a bottom surface of the slider 28 so that the curtain 21 remains deployed, and when the support member is moved away from the ascending/descending trajectory of the slider 28, the curtain 21 is retracted into the interior of the vehicle door.

The curtain 21 may be made from fabric or the like and may be retracted into the interior of the vehicle door in a wound state. When in use, the curtain 21 is withdrawn from the door and deployed adjacent to an inner surface of the door window glass 12.

A frame 14 may be mounted on the interior of the door. The frame 14 may be formed along the longitudinal direction of the vehicle, and the curtain 21 may be received into the interior of the frame 14 in a wound state. The frame 14 may be formed as a cylindrical structure with an incised upper surface for withdrawal and storage of the curtain 21. The incised upper surface of the frame 14 may be provided with a cover 14a for concealing the incised area and a guide 14b for guiding the withdrawal and storage of the curtain 21. Both ends of the frame 14 may be finished with endcaps 14c which are fitted.

A shaft 22 may be rotatably mounted inside the frame 14. On the shaft 22, a lower end of the curtain 21 may be fixed. When accommodating the curtain 21, the shaft 22 may be rotated so that the curtain 21 is wound on the shaft 22 for accommodation. In the case of withdrawal of the curtain 21, the shaft 22 may be rotated as the curtain 21 is withdrawn.

On one side of the shaft 22, a winding spring 23 may be mounted which elastically supports the shaft 22 so that the curtain 21 is wound around the shaft 22. The winding spring 23 may be formed in the form of a leaf spring with both ends connected to the shaft 22 and the frame 14, respectively, to elastically support the shaft 22 to rotate in the direction of winding the curtain 21. By means of the winding spring 23, the deployed curtain 21 may be automatically wound around the shaft 22.

A shade bar 24 may be provided at an upper end of the curtain 21. The shade bar 24 may be arranged in the longitudinal direction of a vehicle and may be fixed to the upper end of the curtain 21, so that the curtain 21 is evenly unfolded when deployed.

The shade bar 24 may be provided with a knob 24a. An occupant, while holding the knob 24a, raises the shade bar 24 so that the curtain 21 is withdrawn, thereby deploying the curtain 21.

The rod 25 supports the shade bar 24 so that the curtain 21 remains in the deployed state. In the door curtain assembly of an embodiment of the present disclosure, since the shade bar 24 is not secured to the door frame or the vehicle body, the rod 25 supports the shade bar 24, thereby allowing the curtain 21 to remain deployed. That is, when the curtain 21 is deployed, the shade bar 24 and the rod 25 ascend together, and when the ascending operation is completed, the rod 25 supports the shade bar 24, thereby allowing the curtain 21 to remain deployed. As such, since the shade bar 24 is not coupled to and secured to the door frame or the vehicle body, the curtain 21 can be mounted on a door with or without the application of a door frame. Thus, the curtain 21 can be applied to a frameless door in which the shade bar 24 cannot be fixed. The rod 25 ascends and descends together with the shade bar 24. With the curtain 21 retracted, the rod 25 is located inside the door, and when the curtain 21 is deployed, the rod 25 ascends together with the shade bar 24, so that the rod is exposed to the outside.

A guide rail 26 guides the ascending/descending of the rod 25. The guide rail 26 may be formed as a hollow cylindrical structure in which the rod 25 and the slider 28 are slidably mounted. Alternatively, the slider 28 may be assembled on one side of the guide rail 26 in a slidable state. A lower end of the guide rail 26 may be fixed to the door through a fixing bracket 27. An upper end of the guide rail 26 may be fixed to the frame 14 side.

The slider 28 may be assembled onto the rod 25 and slidably mounted on the guide rail 26. The slider 28 allows the rod 25 to ascend and descend smoothly on the inner side of the guide rail 26.

In particular, the slider 28 interacts with a support member, i.e., a stopper 31 to be described later, so that the slider 28 ascends by passing through the stopper 31, or the slider 28 is prevented from descending by being caught by the stopper 31.

When positioned at an initial position in the ascending/descending trajectory of the slider 28, the support member impedes the descending operation of the slider 28. One example of the support member may be the stopper 31.

The stopper 31 may be located at the initial position in the ascending/descending trajectory of the slider 28 and fixed to an upper portion of the guide rail 26. The stopper 31 may be mounted at the upper portion of the guide rail 26 where the guide rail 26 is fixed to the frame 14.

The stopper 31 may be hingedly connected at a lower end to the guide rail 26 so as to rotate within a predetermined angular range. The stopper 31 may be moved away from the initial position by the slider 28 as the slider 28 ascends. When rotated and positioned below the slider 28, the stopper 31 prevents the slider 28 from descending. When the stopper 31 is positioned higher than the slider 28, the slider 28 ascends to rotate the stopper 31.

The stopper 31 has an inclined surface 31a that comes into contact with the slider 28 upon ascending of the slider 28, a stop surface 31b that extends from the top of the inclined surface 31a in a direction perpendicular to the ascending/descending direction of the slider 28, and an engaging protrusion 31c that extends from the stop surface 31b on the opposite side of the inclined surface 31a.

The inclined surface 31a may be formed on one side of the stopper 31. The inclined surface 31a may be formed so as to come closer to the ascending/descending trajectory of the slider 28 as it goes towards the top. Accordingly, when the slider 28 ascends, one side of the slider 28 contacts the inclined surface 31a, and the ascending slider 28 rotates the stopper 31 in a direction away from the slider 28. Accordingly, the ascending slider 28 continues to ascend after rotating the stopper 31.

The stop surface 31b may be formed to extend from the top of the inclined surface 31a in a direction perpendicular to the ascending/descending direction of the slider 28. Accordingly, when the slider 28 is seated on the stop surface 31b, the slider 28 may be prevented from descending by the stop surface 31b.

The engaging protrusion 31c may be formed to protrude from the stop surface 31b on the opposite side of the inclined surface 31a. The engaging protrusion 31c restricts the stopper 31 from rotating excessively toward the slider 28. Further, a first cable 33 and a second cable 35 are connected to the engaging protrusion 31c.

On the other hand, the stopper 31 may be mounted to be elastically supported toward the ascending/descending trajectory of the slider 28. That is, a torsion spring 31d may be fitted on a rotary axis of the stopper 31 to elastically support the stopper 31 toward the slider 28. Thus, when the stopper 31 is positioned on the ascending/descending trajectory of the slider 28, the stopper prevents the descending of the slider 28.

A button 32 may be mounted on one side of the door. The button 32 may be operated to retract the deployed curtain 21 into the interior of the door according to an occupant's intention. The button 32 may be formed in a push type, so that when the button 32 is pressed by an occupant, the stopper 31 is disengaged from the bottom surface of the slider 28. For this purpose, the button 32 may be mounted such that a body 32a formed on one side of the door can slide, and the button 32 and the engaging protrusion 31c of the stopper 31 are connected by a first cable 33. Accordingly, when the button 32 is pressed, the first cable 33 pulls and rotates the top of the stopper 31, so that the stopper 31 is moved away from the bottom surface of the slider 28. Between the button 32 and the body 32a, a return spring 32b may be mounted so that, after being operated, the button 32 returns to its original position.

An actuating lever 34 may be rotatably mounted on one side of the door. The actuating lever 34 may be mounted to associate the descending of the door window glass 12 with the retraction of the curtain 21 when the door window glass 12 descends with the curtain 21 deployed.

The actuating lever 34 may be rotatably mounted on a door panel 11 of the door. A middle part of the actuating lever 34 may be hingedly connected to the door panel 11, so that, when one side of the actuating lever 34 is pressed, the actuating lever 34 rotates.

One end of the actuating lever 34 comes into contact with a lower end of the door window glass 12 when the door window glass 12 descends. When one end of the actuating lever 34 is pressed by the descending door window glass 12, the other end of the actuating lever 34 may be rotated to ascend.

The other end of the actuating lever 34 may be connected with the stopper 31 by a second cable 35, so that when the actuating lever 34 is rotated, the stopper 31 is pulled by the second cable 35 and is separated from the bottom surface of the slider 28. The first cable 33 and the second cable 35 are provided in a structure in which the cables are installed inside a tube provided on the outer side.

Meanwhile, a roller 34a may be mounted at one end of the actuating lever 34 to reduce friction between the actuating lever 34 and the door window glass 12 upon descending of the door window glass 12.

The operation of the manually deployable vehicle door curtain assembly according to embodiments of the present disclosure having the above configuration is described as follows.

When an occupant wishes to deploy the curtain 21, he/she raises the knob 24a. When the knob 24a is raised, the shade bar 24 may be raised together, causing the curtain 21 to unwind and withdraw from the door. At the same time, the rod 25 and the slider 28 fixed to the shade bar 24 are also raised together.

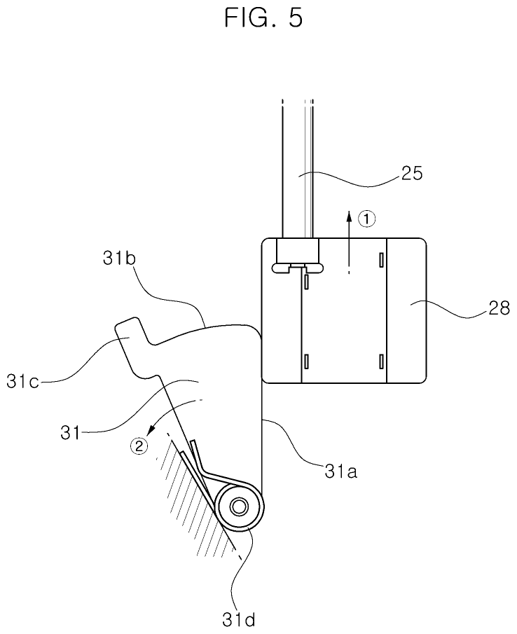

While the slider 28 is rising (see arrow \textcircled{1} in FIG. 5) so that the side of the slider 28 abuts against the inclined surface 31a of the stopper 31, the stopper 31 is rotated in a direction away from the slider 28 (see arrow \textcircled{2} in FIG. 5).

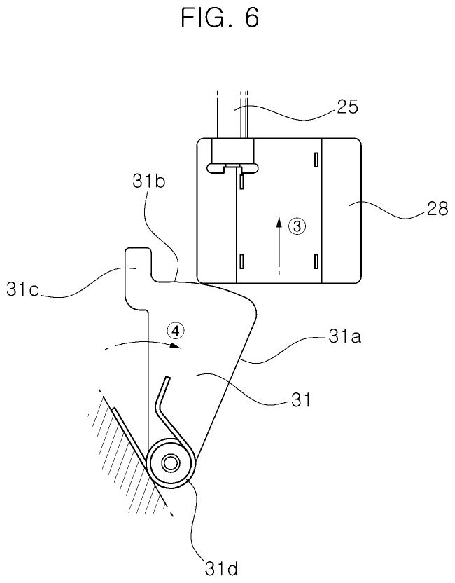

When the knob 24a is maximally raised so that the bottom surface of the slider 28 passes through the stop surface of the stopper 31 (see arrow \textcircled{3} in FIG. 6), the stopper 31 is rotated and positioned below the bottom surface of the slider 28 (see arrow \textcircled{4} in FIG. 6) by the action of the torsion spring 31d. When the bottom surface of the slider 28 is positioned higher than the stop surface 31b of the stopper 31, the stopper 31 prevents the descending of the slider 28, so that the curtain 21 can remain deployed even when the occupant releases the knob 24a.

In this case, since the shade bar 24 is not fixed to the door or the vehicle body, the shade bar may ascend to the top of the door window glass 12, thus maximally covering the door window glass 12. In other words, the shade bar 24 may remain in contact with the top of the door or the vehicle body, so that no gap is formed at the top of the shade bar 24, thus improving the covering performance of the curtain 21.

However, the curtain 21 can only remain deployed when the door window glass 12 is maximally raised. That is, when the door window glass 12 descends, the lower end of the door window glass 12 rotates the actuating lever 34, causing the stopper 31 to be moved to the downward side of the slider 28, so that even if the curtain 21 is deployed, the curtain 21 does not remain in that state and is retracted back into the interior of the door when the occupant releases the knob 24a.

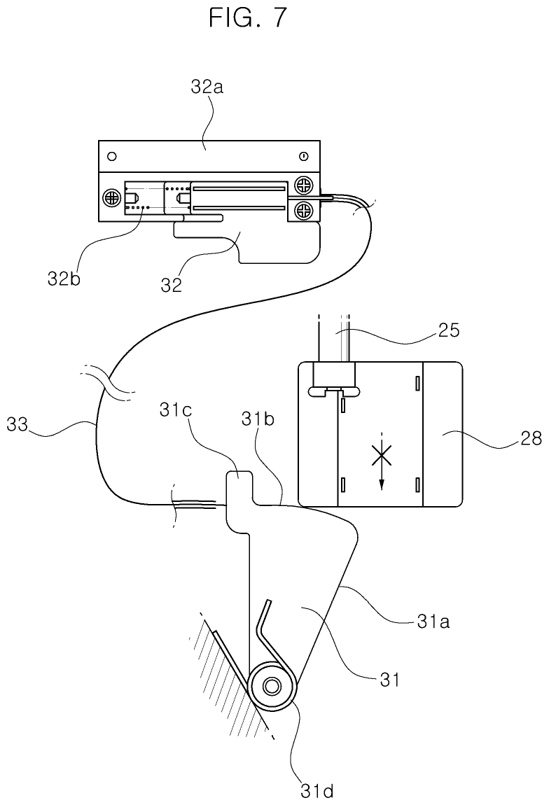

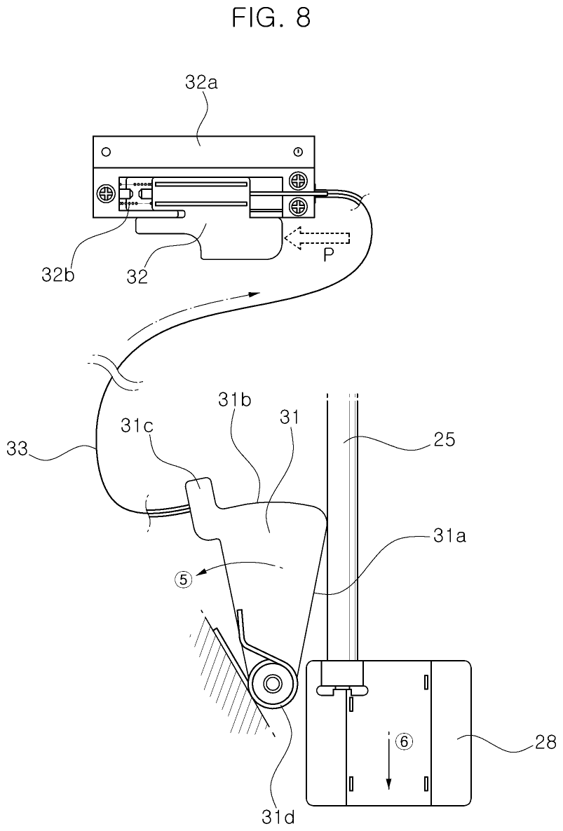

FIGS. 7 and 8 illustrate a state in which the curtain 21 is manually retracted from the deployed state by the occupant.

In the state in which the curtain 21 is deployed by the occupant, the bottom surface of the slider 28 is supported on the stop surface 31b of the stopper 31, so that the slider 28 cannot descend, so the curtain 21 remains in the deployed state.

When an occupant wishes to retract the curtain 21, the occupant presses the button 32 (see arrow P in FIG. 8). When the button 32 is pressed, the button 32 pulls the first cable 33 so that the stopper 31 rotates in a direction in which the slider 28 is unrestricted (see arrow \textcircled{5} in FIG. 8).

Once the slider 28 is unrestrained, the curtain 21 may be wound by the winding spring 23, lowering the shade bar 24, the rod 25, and the slider 28 (see arrow \textcircled{6} in FIG. 8). When the bottom surface of the slider 28 is lower than the stop surface 31b, the shade bar 24, the rod 25, and the slider 28 may continue to descend by the elastic force of the winding spring 23 winding the curtain 21, and the curtain 21 may be wound around the shaft 22 and retracted into the interior of the door.

In this way, when the occupant simply presses the button 32, the deployed curtain 21 may be automatically retracted into the interior of the door.

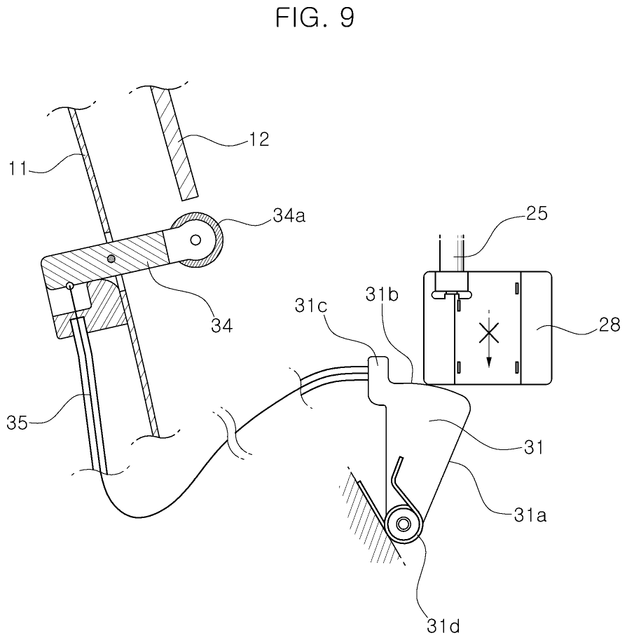

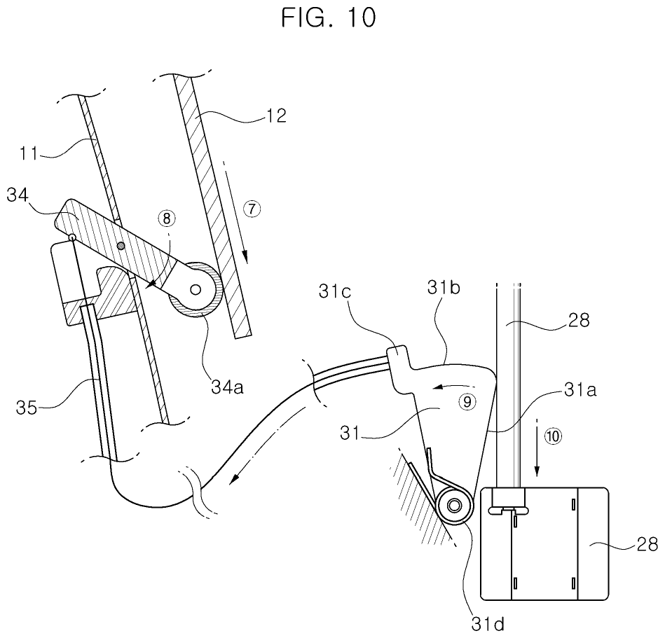

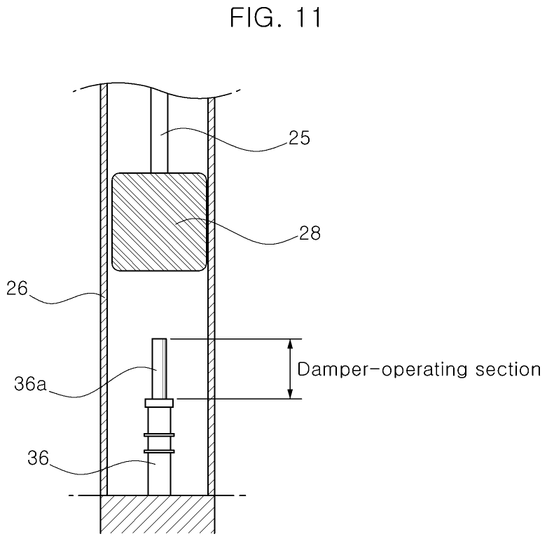

In FIGS. 9 and 10, a process is illustrated in which, with the curtain 21 deployed, when the door window glass 12 descends, the curtain 21 may be retracted in coordination with the descending of the door window glass 12.

With both the door window glass 12 and the curtain 21 raised, the stop surface 31b of the stopper 31 supports the slider 28, so that the curtain 21 remains in the deployed state (see FIG. 9).

When an occupant operates a switch (not shown) to lower the door window glass 12, in conjunction with the descending of the door window glass 12, the curtain 21 also may be retracted into the interior of the door.

When the occupant operates the switch to lower the door window glass 12, a regulator (not shown) mounted inside the door lowers the door window glass 12. When the door window glass 12 descends, the lower end of the door window glass 12 rotates the actuating lever 34 (see arrows \textcircled{7}, \textcircled{8} in FIG. 10). As the door window glass 12 descends, the lower end thereof pushes down an end of the actuating lever 34, causing the actuating lever 34 to rotate.

As the actuating lever 34 rotates, the actuating lever 34 pulls the second cable 35 to rotate the stopper 31 in a direction away from the ascending/descending trajectory of the slider 28 (see arrow \textcircled{9} in FIG. 10). When the lower end of the slider 28 is disengaged from the stopper 31, the curtain 21 may be wound by the winding spring 23 to lower the shade bar 24, the rod 25, and the slider 28 (see arrow \textcircled{10} in FIG. 10). Accordingly, the curtain 21 may be received inside the door so as to be wound around the shaft 22, and the shade bar 24, the rod 25, and the slider 28 descend.

Meanwhile, when the curtain 21 is retracted into the door, either by the occupant pressing the button 32 or in conjunction with the descending of the door window glass 12, the slider 28 may be cushioned by a first damper 36. During a period of time immediately prior to the completion of the descending of the slider 28, the slider may be in contact with a contactor 36a and the first damper 36 cushions the impact generated by the blow of the slider 28.

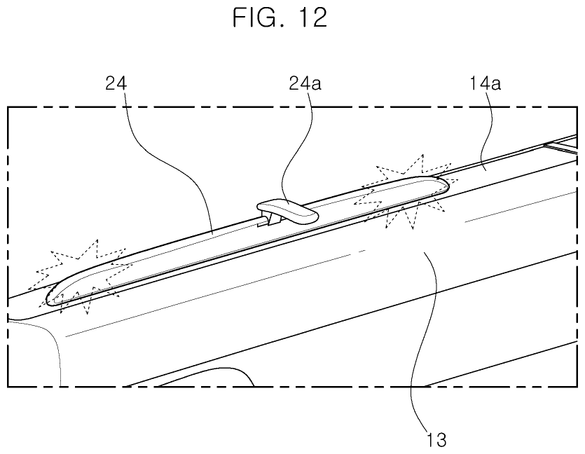

At this time, the shade bar 24 contacts the door trim 13 in a decelerated state, thereby preventing the shade bar 24 from striking the door trim 13, and thereby improving room quietness. In other words, without the first damper 36, as illustrated in FIG. 12, at the moment when the retraction of the curtain 21 is completed, the shade bar 24 strikes the door trim and produces an impact sound. However, by providing the first damper 36, it is possible to prevent the generation of an impact sound when the shade bar 24 comes into contact with the door trim.

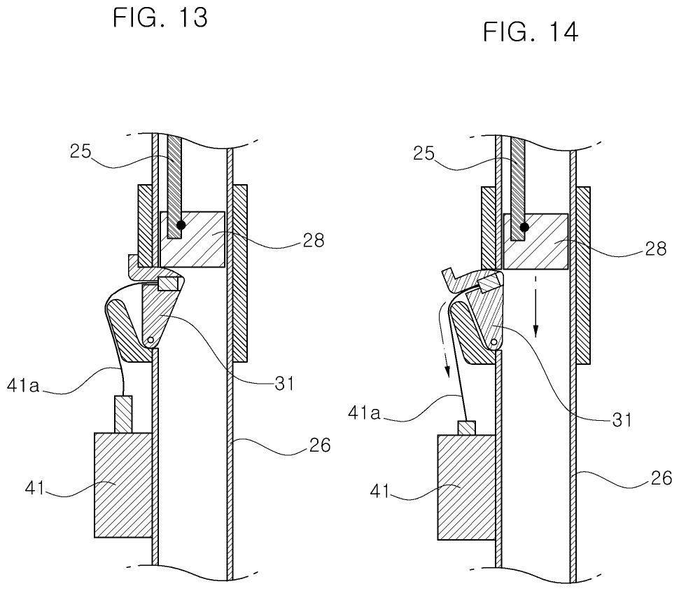

FIGS. 13 and 14 illustrate another exemplary embodiment in which the stopper 31 is operated by a first actuator 41.

The first actuator 41 may be telescopically installed on one side of the door, for example on the outer side of the guide rail 26.

The first actuator 41 may be connected with the stopper 31 by an actuating wire 41a, such that the stopper 31 is actuated by the first actuator 41. For example, as illustrated in FIG. 14, when the first actuator 41 is reduced in length, the first actuator is configured to pull the actuating wire 41a.

The first actuator 41 may be operative to disengage the stopper 31 from the slider 28 when the switch (not shown) is operated. The switch may be a switch for raising/lowering the door window glass 12 or a separate switch for retracting the curtain 21. If the switch is provided as a separate switch for the retraction of the curtain 21, it is not necessary to apply the button 32.

When the curtain 21 is deployed by an occupant, the slider 28 may be supported by the stopper 31 and cannot be lowered, so that the curtain 21 can remain deployed (see FIG. 13).

Subsequently, when the occupant operates the switch in order to retract the curtain 21, the first actuator 41 pulls the actuating wire 41a to disengage the stopper 31 from the slider 28 (see FIG. 14). In this state, since the slider 28 is not prevented from descending by the stopper 31, the curtain 21 is received inside the door.

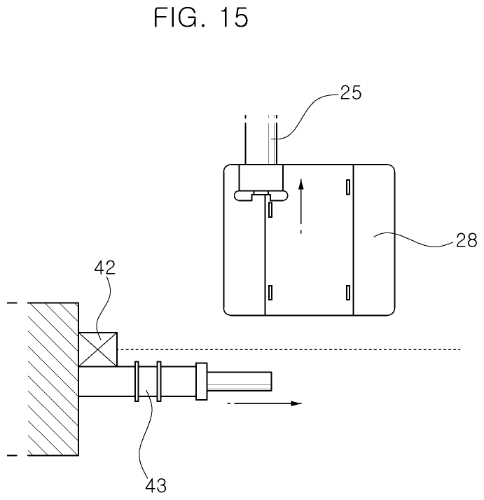

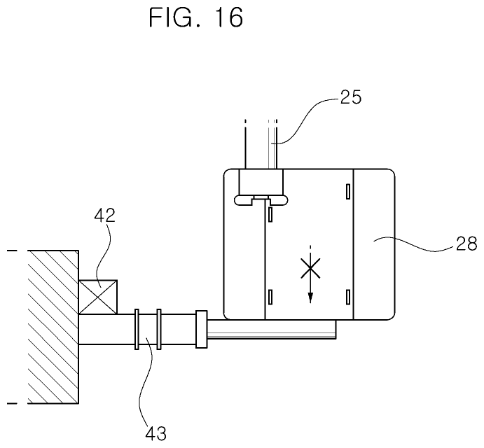

FIGS. 15 to 17 illustrate a further exemplary embodiment in which the descending of the slider 28 is directly limited by a second actuator 43, as a support member, instead of the stopper 31.

The second actuator 43 may be mounted so as to be extensible in a direction perpendicular to the ascending/descending direction of the slider 28. When the second actuator 43 is stretched, the second actuator 43 supports the bottom surface of the slider 28, thereby preventing the slider 28 from descending, so that the curtain 21 remains in the deployed state. Meanwhile, the second actuator 43 may be connected with a switch (not shown), so that when there is an operation of the switch to lower the door window glass 12, the second actuator 43 may decrease in length to be disengaged from the slider 28. The switch may be a switch for raising/lowering the door window glass 12 or a separate switch for retracting the curtain 21.

A sensor 42 for detecting the position of the slider 28 may be installed on the upper part of the second actuator 43.

When it is detected by the sensor 42 that the slider 28 is positioned above the sensor 42, the second actuator 43 may be extended (see FIG. 15). When an occupant deploys the curtain 21, the slider 28 also may be raised, which is detected by the sensor 42, and the second actuator 43 is extended.

When the second actuator 43 is stretched, the second actuator 43 prevents the slider 28 from descending, so that the curtain 21 remains deployed (see FIG. 16).

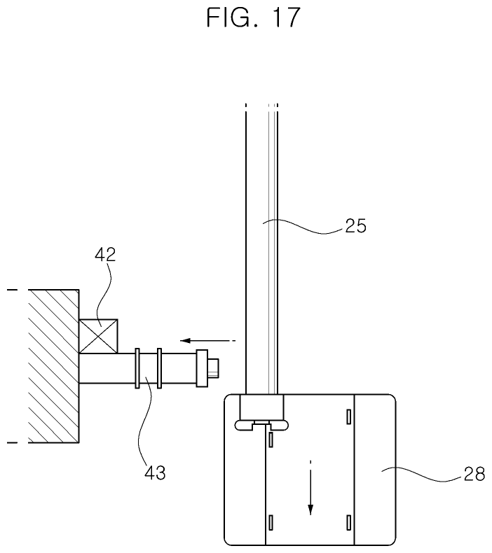

When an occupant operates the switch to lower the door window glass 12, the second actuator 43 also may be reduced in length. When the second actuator 43 is reduced in length, the second actuator no longer supports the bottom surface of the slider 28, so that the rod 25 and the slider 28 can be lowered (see FIG. 17). Accordingly, the curtain 21 can be retracted into the interior of the door.

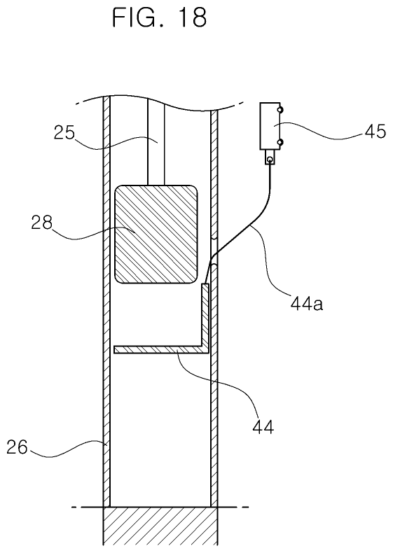

FIG. 18 illustrates another exemplary embodiment of the damper.

A seating bracket 44 may be slidably installed at the lower end of the guide rail 26. At the point of completion of the descending of the slider 28, the slider 28 may be seated on the seating bracket 44.

A second damper 45 may be installed inside the door. The second damper 45 may be connected with the seating bracket 44 by a buffer wire 44a.

Accordingly, at the time when the descending of the slider 28 is completed, with the slider 28 seated on the seating bracket 44, the buffer wire 44a may be pulled out and cushioned by the second damper 45.

While embodiments of the present disclosure as described above have been illustrated with reference to the drawings, the embodiments of the present disclosure are not limited to the described embodiments, and it is obvious to those of ordinary skill in the art that various modifications and variations can be made without departing from the spirit and scope of the present disclosure.

What is claimed is:

1. A manually deployable vehicle door curtain assembly, the assembly comprising:
a curtain capable of being retracted into a vehicle door and deployed to cover a door window glass;
a rod configured to be mounted on the vehicle door and to be simultaneously movable with the curtain to support the curtain;
a slider slidably coupled with the rod and movable up and down together with the rod; and
a support member configured to allow or prevent descending movement of the slider.

2. The assembly according to claim 1, wherein:
in a deployed state of the curtain, the support member is positioned at an initial position to support a bottom surface of the slider so that the curtain remains in the deployed state; and
in a state in which the support member is moved away from the initial position, the slider is movable so as to retract the curtain into an interior of the vehicle door.

3. The assembly according to claim 1, wherein the support member comprises a stopper mounted to be elastically supported at an ascending/descending trajectory of the slider on the rod.

4. The assembly according to claim 3, wherein the stopper comprises:
an inclined surface configured to come into contact with the slider during an ascending movement of the slider; and
a stop surface extending from an upper end of the inclined surface in a direction perpendicular to the ascending/descending trajectory of the slider.

5. The assembly according to claim 4, wherein the stopper comprises, on the opposite side of the inclined surface, an engaging protrusion extending from the stop surface.

6. The assembly according to claim 3, wherein the stopper is rotatably mounted on the vehicle door and is elastically supported toward the ascending/descending trajectory of the slider by a torsion spring.

7. The assembly according to claim 3, further comprising a button on one side of the vehicle door, wherein the button is configured to operate the stopper, and wherein in a state in which the button is operated, the stopper is configured to move away from the ascending/descending trajectory of the slider.

8. The assembly according to claim 7, wherein the button is connected to the stopper by a first cable, and in the state in which the button is operated, the first cable is configured to be pulled to move the stopper away from the ascending/descending trajectory of the slider.

9. The assembly according to claim 3, further comprising:
a first actuator configured to actuate the stopper away from the ascending/descending trajectory of the slider; and
an actuating wire connecting the first actuator and the stopper, wherein in a state in which the first actuator pulls the actuating wire, the stopper is configured to move away from the ascending/descending trajectory of the slider.

10. The assembly according to claim 1, wherein the support member comprises a second actuator telescopically mounted in an ascending/descending trajectory of the slider, and wherein the assembly further comprises a sensor mounted on an upper portion of the second actuator, the sensor being configured to detect the slider.

11. The assembly according to claim 10, wherein:
in a state in which the sensor detects that the slider is positioned higher than the sensor, the second actuator is configured to stretch to support a bottom surface of the slider so that the curtain remains in a deployed state; and
in a state in which a switch is operated, the second actuator is configured to move away from the ascending/descending trajectory of the slider so that the curtain is retracted into an interior of the vehicle door.

12. The assembly according to claim 1, further comprising a shade bar mounted on an upper portion of the curtain along a longitudinal direction of the vehicle door, the shade bar being coupled to an upper end portion of the rod and movable together with the rod.

13. A manually deployable vehicle door curtain assembly, the assembly comprising:
a curtain capable of being retracted into a vehicle door and deployed to cover a door window glass, the vehicle door comprising an actuating lever operable by descending of the door window glass;
a rod configured to be mounted on the vehicle door and to be simultaneously movable with the curtain to support the curtain;
a slider slidably coupled with the rod and movable up and down together with the rod; and
a stopper configured to allow or prevent descending movement of the slider, wherein in a state in which the actuating lever is operated by the descending of the door window glass, the stopper is configured to move away from an ascending/descending trajectory of the slider.

14. The assembly according to claim 13, wherein the actuating lever is configured to be rotatably mounted on the vehicle door so that a first side of the actuating lever is rotatable by a lower end of the door window glass upon the descending of the door window glass and a second side of the actuating lever is connected with the stopper by a second cable such that the stopper is configured to move away from the ascending/descending trajectory of the slider upon rotation of the actuating lever.

15. The assembly according to claim 13, further comprising a roller mounted on one side of the actuating lever.

16. The assembly according to claim 9, wherein the vehicle door comprises a guide rail extending in an ascending/descending direction of the rod, and wherein the slider is slidably mounted on the guide rail.

17. The assembly according to claim 16, wherein the guide rail further comprises a damper configured to cushion the slider upon completion of a descending operation of the slider.

18. The assembly according to claim 17, wherein the damper is mounted at a lower end of the guide rail, and wherein a contactor in contact with the slider is mounted at an upper end of the damper.

19. The assembly according to claim 17, wherein the damper is mounted on an outer side of the guide rail, wherein a seating bracket is slidably mounted in the guide rail and configured to receive the slider upon the completion of the descending operation of the slider, and wherein the seating bracket is connected with the damper by a buffer wire.

20. A door of a vehicle, the door comprising:
a door glass for light-admission and ventilation; and
a door curtain assembly comprising:
a curtain retractable into the door and deployable to cover the door glass;
a rod mounted on the door and simultaneously movable with the curtain to support the curtain;
a slider slidably coupled with the rod and movable up and down together with the rod; and
a support member configured to allow or prevent descending movement of the slider.
